(19) United States
(12) Patent Application Publication
(10) Pub. No.: US 2014/0149488 A1
(43) Pub. Date: May 29, 2014

(54) SYSTEM AND METHOD FOR ENGAGING A MOBILE DEVICE

(71) Applicant: NICE-SYSTEMS LTD., Ra'anana (IL)

(72) Inventors: Yaron BIALY, Madrid (ES); Yonatan Ofir, Netanya (IL); Shahaf Rozanski, Nes-Ziona (IL); Eitan Kovacs, Netanya (IL)

(73) Assignee: NICE-Systems Ltd., Ra'anana (IL)

(21) Appl. No.: 13/685,034

(22) Filed: Nov. 26, 2012

(51) Int. Cl. H04W 4/00

(52) U.S. Cl. CPC H04W 4/00
USPC 709/203

(57) ABSTRACT

A system and method for engaging a mobile device. An event related to an application may be captured on a mobile device by code embedded in the application. Information related to the event may be sent to a server. A server may compute a next best action to take. A communication channel may be selected based on the event and based on a set of rules. A session may be established according to the selected communication channel.

### BACKGROUND OF THE INVENTION

The growing popularity of wireless computing devices influences the motivation and need for tracking usage of these devices. Some systems and methods for tracking execution of applications and/or user interactions involve modifying an application such that a module external to the application is called from selected points within the application, during run-time. Such external module may perform various analytics, processing and logging. For example, profiling of an application or collecting usage statistics may be achieved by an external module.

However, current systems and methods suffer from various drawbacks. For example, in order to track an application execution or user interactions, known systems and methods typically require intimate knowledge of the tracked or monitored application. For example, known methods typically require adding code to the monitored application, e.g., code must be added to an application for each event which is to be detected. Accordingly, when an application is modified, the relevant code must also be modified.

Other systems (e.g., testing tools) simply capture all events related to an application and process (possibly in off-line mode) captured events. Yet other methods and systems monitor communications between a monitored application and a server, and thus may not fully monitor an application, e.g., are unable to track events which are not reported or communicated to the server.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 shows an exemplary system setup according to embodiments of the invention;

FIG. 2 is a flowchart diagram according to some embodiments of the present invention; and

FIG. 3 shows high level block diagram of an exemplary computing device according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those having ordinary skill in the art that the invention may be practiced without these specific details. In other instances, well-known methods, procedures, components, modules, units and/or circuits have not been described in detail so as not to obscure the invention.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like.

Unless explicitly stated, the method embodiments described herein are not constrained to a particular order or sequence. Additionally, some of the described method embodiments or elements thereof can occur or be performed at the same point in time or overlapping points in time. As known in the art, an execution of an executable code segment such as a function, task, sub-task or program may be referred to as execution of the function, program or other component.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

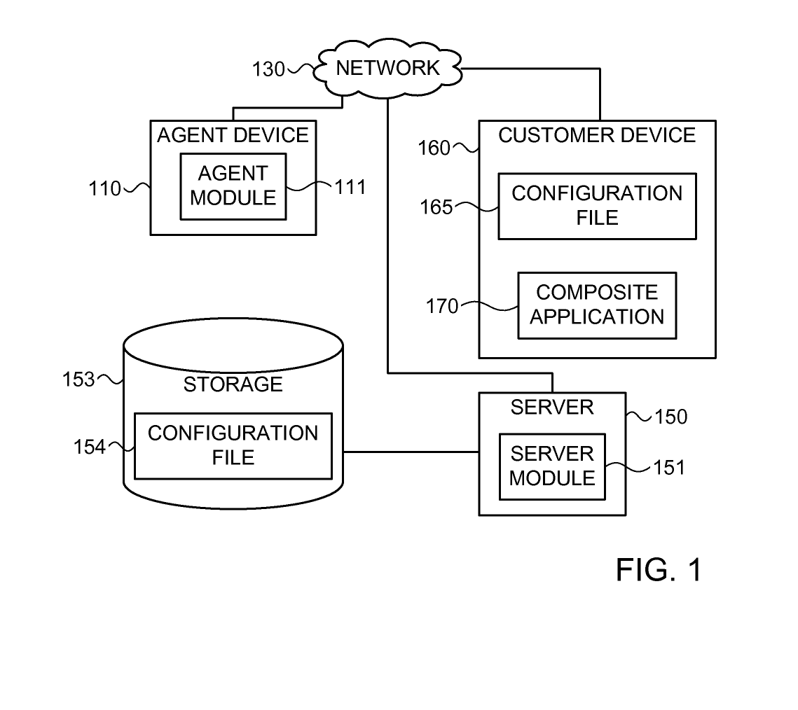

Reference is made to FIG. 1 that shows an exemplary system setup according to embodiments of the invention. As shown, a setup may include agent device 110 that may include, or may be operatively connected to, agent module 111. A setup may include a customer device 160. As shown, customer device may include a composite application 165 and a configuration file 165. A setup may include a server 150 that may include, or be operatively connected to, a server module 151. As shown, server 150 may be operatively connected to a storage 153, storage 153 may include configuration file 154. A setup may include network 130 that may enable agent device 110, customer device 160 and server 150 to communicate.

For the sake of clarity and simplicity, only some of the components and/or devices in a possible system or setup are shown. For example, a large number of devices such as, or similar to, agent device 110 may be included in an embodiment. Likewise, a large number of customer devices such as, or similar to, customer device 160 may be included in a system according to embodiments of the invention. Any number of servers similar to server 150 may be included in a system. For example, a system according to an embodiment, deployed in a contact center, may be scaled up by adding servers in the contact center, such that a large number of customers, using devices similar to customer device 160, may be served. Accordingly, it will be understood that methods and operations described with respect to devices 110 and 160 and/or server 150 may be performed by any one of a large set of similar devices in a system or setup according to embodiments of the invention.

For the sake of simplicity and clarity, the invention in the context of a contact center is mainly referred to herein. However, it will be understood that embodiments of the invention are not limited to a contact center and may be realized or applicable in other setups, scenarios or configurations. In one setup, agent device 110 and server 150 may be located within, or otherwise associated with, a contact center, an enterprise, a department of an organization or any entity designed for interacting with customers, clients or other entities. In another setup or embodiment, although associated with a contact center (or other entity as discussed), agent device 110 may be physically located elsewhere or remotely, e.g., agent device 110 may be located in a home of an agent and server 150 may be located within a contact center. Accordingly, although the discussion herein will mainly relate to agents (e.g., humans such as service representatives communicating with customers or users) in a contact center, embodiments of the invention may be realized in other setups or configurations.

Agent device 110 may be any applicable device, used by service representatives or agents in an enterprise or call center, for interacting over a session with a customer. Any relevant communication channel may be supported by agent device 110. For example, agent device 110 may support both an audio channel usable for telephone calls and a data communication channel supporting a web sessions (e.g., a chat session, a document sharing session or a connection to the internet). Other communication channels supported by device 110 may support a text based session, e.g. a short message service (SMS) session or an electronic mail (e-mail) session. For example, agent device 110 may be a computing device, a telephone or smartphone or a combination thereof. In an embodiment, agent device 110 may be a desktop or laptop computer that may enable both communicating over a computer network and over a voice or telephony network, e.g., voice over internet protocol (IP) (VoIP). Accordingly, agent device 110 may enable communicating with customer device 160, server 150 over a number of communication channels or sessions. A session may be, for example, a period of interaction or communication between a user or customer, and an agent or other person. A session may be, for example, a chat session between a user and agent, where text is exchanged via a chat function; a telephone conversation between a user and agent; or another communication session.

Customer device 160 may support both voice and data channels. For example, customer device 160 may be a wireless or mobile telephone, a smartphone, a laptop or other computer used by a customer to call, or interact with, an agent and/or interact with a remote server over a network. For example, customer device 160 may be a commercial product, e.g., an Apple iPhone 5 device, or a Samsung Galaxy S III device. For example, customer device 160 may a device supporting communication platforms, protocols or technologies such as a wireless local area network operating according to the IEEE 802.11 standards family (e.g., Wi-Fi), International Mobile Telecommunications-2000 (IMT-2000), also known as 3G or ‘3rd Generation’ family of standards for mobile telecommunications and/or Global System for Mobile Communications (GSM).

As referred to herein, the term “Android” refers to an operating system designed primarily for touch-screen mobile devices such as smartphones provided by Google Inc. of Mountain View, Calif. Although the description herein mainly refers to applications executed on Android, it will be understood that other environments and/or operating systems may be contemplated. An application executed on an Android platform may be referred to herein as an activity (as is customary in the industry). Accordingly, where applicable, the terms “application” and “activity” may be used herein interchangeably.

Network 130 may be, may comprise or may be part of a private or public internet protocol (IP) network, or the internet, or a combination thereof. Additionally or alternatively, network 130 may be, may comprise or may be part of a global system for mobile communications (GSM) network. For example, network 130 may include or comprise an IP network such as the internet, a GSM related network and any equipment for bridging or otherwise connecting such networks as known in the art. Network 130 may be, may comprise or be part of an integrated services digital network (ISDN), a public switched telephone network (PSTN), a public or private data network, a local area network (LAN), a metropolitan area network (MAN), a wide area network (WAN), a wireline or wireless network, a local, regional, or global communication network, a satellite communication network, a cellular communication network, any combination of the preceding and/or any other suitable communication means. Accordingly, numerous elements of network 130 are implied but not shown, e.g., access points, base stations, communication satellites, GPS satellites, routers, telephone switches, etc.

A portion of network 130 may be internal to a contact center and another portion of network 130 may be external to a contact center. For the sake of simplicity, such possible portions are not shown, however, it will be understood that network 130 may be configured to enable any configuration or setup required. For example, secured communication (e.g., confined to a contact center) between an agent and an expert (a person with specific knowledge) may be enabled by network 130. Communication between an agent or a server in a contact center and a customer over a public or global network may be enabled by a public or global network portion included in network 130. Suitable network devices such as switches, routers and firewalls may be included in network 130 to enable any required configuration, e.g., a separation of an internal and external networks or enabling devices that use wireless communication to communicate with devices using wired networks.

Server 150 may be any suitable server or computing device or system or it may be a number of computing devices. Storage 153 may be any suitable storage device or system. Storage 153 may be or may include a database and a database application. For example, storage 153 may include or may be, a hard disk drive, an array of hard disks, a Compact Disk (CD) drive or other suitable removable and/or fixed storage units, or it may include or may be a USB storage device or a network storage device or system.

Agent module 111 and server module 151 may be or may include specific hardware modules, e.g., provided as cards that may be installed on a computing device. In other embodiments, modules 111 and 151 may be an application, e.g., an executable code segment or a set of instructions designed to cause a computing device to perform methods described herein. For example, module 111 may be an application installed on a computer or a wireless computing device. Modules 111 and 151 may be or may include hardware, firmware, software or any combination thereof.

Composite application 170 may include an original (or input) application and additional code. As described herein, a process or unit may receive an input application and may embed or weave code into the input application to produce an output or composite application. Configuration file 165 may include parameters or configuration data used by code in composite application 170.

Configuration files 154 and configuration file 165 may be any suitable construct or object (e.g., a Java ARchive (JAR) or other file) that includes parameters or other configuration data as described herein. Configuration file 154 may include references or identification parameters or values used by code in composite application 170 at run time. For example, names of views (e.g., screens or windows) or items may be included in configuration file 154. Other information included in configuration file 154 may be identification codes or values (e.g., as generated or determined at compilation time) and rules. For example, a name and an identification value of a button in a screen or monitor view presented by composite application 170 may be stored in configuration file 154. A rule related to the button or to an action may be stored in configuration file 154. A rule may include one or more actions, e.g., to be performed when an event occurs.

It will be understood that configuration file 154 may be divided into a number of objects or files, however, for the sake of clarity, a single object is shown and discussed herein. It will be understood that a large number of configuration files similar to configuration file 154 may be stored on storage 153. More than one configuration file may be loaded into a memory of customer device 160. For example, a configuration file may be loaded for each application executed on customer device 160. In other cases, two or more configuration files may be used in association with a single application (or apk as referred to in Android jargon). Configuration file 165, may be loaded, over network 130, from storage 153 to customer device 160 by module 151 and/or by code in composite application 170.

According to embodiments of the invention, configuration files 154 and 160 may be generated based on an examination and/or processing of an input or original application. An original or input application may be provided (e.g., in the form of source code) by any applicable entity. The terms “original application” and “input application” as used herein refer to an application provided as input to embodiments of the invention and may be used herein interchangeably. For example, an original or input application may be a mobile application provided by a bank to its customers, enabling the customers to interact with the bank over the Internet, using their mobile devices. In other embodiments, an input application may be an application provided by an academic institution to students, by a medical institution to patients etc.

Typically, input to the examination of an original application may be provided by the organization that provides the input application. For example, the service and marketing departments of an organization may indicate specific screens (or sequences of screens) displayed on a monitor or screen, presentable by the input application, which are of interest. Business rules as defined by the organization that provides the original application may be used in order to determine or select screens, items or events and data related to selected screens, items or events may be included in configuration file 154.

Specific interactions, possibly associated with specific screens may similarly be indicated. Additional information provided by the entity that provides the original application may include references to objects used by the input application. For example, names of objects such as constant or variable parameters as used by the code of the input application may be provided. Other references may be related to objects that define views or controls, e.g., a name of a view as used in a code of the input application. For example, a screen or view, displayed on a monitor of a device, including a username field, provided by an original application, might be indicated as a view of interest that is relevant to an embodiment.

For example, a view, screen or item in a view where a name of a user appears (or entered) may be indicated as a view or object of interest. In an example, the user name field or screen is referenced, in the code of the input application, as “txt_username”. Accordingly, the string “txt_username” may be recorded as part of the process of generating a configuration file. In addition to recording a name or string associated with a view or item, additional data or parameters may be recorded. For example, a view may include graphical user interface (GUI) items or elements such as GUI clickable buttons, selection menus, images and the like. Names and other data related to such elements may be recorded. Items on a GUI such as buttons may be “clicked', pressed, or otherwise operated by a used through known means, such as touch screens, mouse devices, etc. For example, when recording a name of a button, the name of the view in which the button is presented may be recorded or associated with the name of the button. Data related to attributes, actions or events may be recorded. For example, data indicating that an item is a clickable button, image or a text input box may be recorded. Similarly, references to additional views, interactions (e.g., a click on a specific button in a specific screen) or other aspects of the original application may be recorded and/or saved.

A specific event related to a specific item may be indicated as an event of interest (e.g., by the sales department of the organization providing the original application). For example, a choice or selection of a specific option in a multi option menu may be indicated as an event of interest. In an embodiment, data related to a specific event, possibly selected from a plurality of events associated with a single item, may be captured, stored or recorded such that the specific event may be identified when it occurs in run time (when the module or software which operates or displays the event is executed). References or indications related to a state of the original application (during execution) may also be recorded. For example, a state of an activity may be determined based on a sequence of views presented and user interactions with the activity. Data enabling identifying sequences or other aspects of an execution of an activity may be recorded and used in order to determine a state of the activity at run time.

Source code variables or parameters may be associated with an ID, e.g., at compilation time, when source code is used to generate executable or binary code. For example, in a first compilation of an application, “txt_username” can have an identification value of 0x7f070008 and in a second, subsequent compilation of the application, “txt_username” can have an identification value of 0x7f070002. Generally, views in an Android environment are unaware of their name as used in the source code, rather, identification (ID) values are used. Accordingly, a method according to embodiments of the invention may map strings or other objects to their respective IDs. The term “ID” may be used herein to refer to identification or reference parameter or values, e.g., a code or value assigned to denote a name of a view, a button or menu, as determined by a compilation or generation of executable code.

Generally, mapping of ID codes or values generated at compile time to their respective names or references in the code of the original application enable embodiments of the invention to translate ID values (obtained from an activity or an operating system at run time) to their respective names or references. Various methods, e.g., hash tables, may be utilized in order to increase speed and efficiency of the actual translation or mapping in real-time.

Mapping of names or references in the code to the assigned IDs may be done by examining data produced during compilation. For example, compiling an application for Android includes generating a file named R.id. The R.id file is generally used as a translation table, mapping view (and other object) names to their respective ID values as used in the executable code. Accordingly, the R.id file may be examined and a mapping of names or other references to their respective ID values may be determined and the mapping may be recorded. Systems other than Android may be used with embodiments of the present invention.

Mapping of names or references to their ID values may be done in run-time (e.g., using the “Reflection” feature available in Java™ and supported by Android).

Generally, Reflection as referred to herein is the ability to examine and modify executable code at run time, while the code is executed. For example, values, meta-data, properties and functions in code may be modified or examined using Reflection. Reflection is readily available for standard Java and supported on Android.

In other embodiments, examining the R.id file may be done prior to loading of an application to a smartphone or other device, e.g., after compiling the application. Accordingly, a mapping of names, views, controls and the like (e.g., selected based on an indicated interest as described herein) to their IDs as used by the related executable code may be available to embodiments of the invention and may be used as described herein. It will be noted that mapping of names to their ID codes, parameters or values, may only need to be done once for each compilation of an application since the ID values are determined at compilation time and remain unchanged for a compiled application.

The scope of data included in a configuration file (e.g., configuration file 154) may be implementation dependent. For example, if obtaining IDs is performed in offline, e.g., when a composite application is generated, prior to installing the composite application on a wireless device, then configuration file 154 may include names or references as they appear in the source code and their respective IDs. In another embodiment or implementation, the IDs may be obtained in real-time, e.g., by examining the R.id object loaded into memory at run time.

A configuration file (e.g., configuration file 154) may include rules, thresholds or criteria. Rules in configuration file 154 may be defined based on business rules or other input provided by the organization that provides the original application. For example, with respect to a screen or view related to filling in a form for an online loan, a rule in a configuration file may dictate an action if an amount below a threshold is entered into an input text box in the view. The rule may define or indicate a second, different action, if the amount entered is above the threshold. Complex rules may be included in a configuration file, for example, a rule may be related to a plurality of items or events.

Generally, based on information in the (source and binary) code of an original application and a set of business or other rules, a number of configuration files may be generated. A first configuration file may be similar to configuration files 154 and 160 and may include at least names of items, e.g., text strings associated with selected views or items as described herein. A second configuration file may be used by server module 151. A configuration file used by server module 151 (not shown) may include references and IDs as described herein as well as a large number of possibly complex rules.

An input or original application may be processed and code may be added to the application to produce a composite application. A composite application may include an original application and additional code designed to identify a condition or event related to an execution of the original application. The code added to (or weaved in to, or embedded in) an original application is further designed to perform one or more actions upon identifying an event, state or condition. Generally, weaving as referred to herein relates to modifying a first executable code segment by embedding in the first code segment a second executable code segment. Typically, the first executable code segment is unaffected by the insertion. For example, code weaved into an original code may add a functionality to the original code without otherwise effecting the operation of the original code.

For example, upon presentation of a screen, e.g., on a monitor, to a user (or view as referred to in the Android environment), code embedded in the original application may be executed. In another example, a click on a button in a view may be an event captured, processes and acted upon, by code embedded in the original application. When used herein, capturing an event may include one or more of analyzing the event or related data, analyzing information or actions representing the event, and storing or transmitting information or data or derived information or data representing the event or portions of the event. When used herein, an event may be an interaction of a user with an application, an invocation of an application or executable code or it may be an event related to an operation of an operating system, e.g., an expiration of a timer, a software or hardware interrupt as known in the art and the like. An event may be a screen related event, e.g., a presentation of information on a screen or display or an interaction of a user with displayed information. For example, a screen event may be a presentation of a clickable button on a display and a user input event may be a click on the presented button. For example, a click on a button may include a user indicating or choosing an on-screen (displayed on a monitor) representation of a button or other interactive screen object by, for example, indicating on a touch screen, using a mouse, etc.

Any method for embedding code in an original application may be used. For example, AspectJ™, a Java™ programming language extension may be used in order to embed (or weave, as known in the art) executable code into an original application without altering or otherwise influencing the operation of the original application. Generally, a Java compiler compiles Java code into class files, an AspectJ™ compiler then injects (or weaves) code (e.g., advices (advice functions) or code snippets as known in the art) into the class files in the selected locations (known as pointcuts), thus, modified class files are generated. Other methods of inserting, embedding, or weaving code or software into other code, applications or software may be used. The modified class files are converted into Dalvik Executable (.dex) files and further packaged into an application package (.apk) file that may be executed on Android. Accordingly, AspectJ™ enables “injection” of code, using pre-compile time weaving, into relevant parts of the code, without modifying those parts of the code. Using AspectJ™ or other tools or methods, code may be inserted into an original application such that upon detection of an event such as user interaction or presentation of a screen or view, the inserted code is executed.

It will be understood that any relevant event or condition may be identified and acted upon. An event as referred to herein may be or may include, for example, pausing an activity, resuming an activity, terminating an activity or changing content in a screen. An event may be or may include any user action, e.g., a touch on a screen, a selection in a menu and the like. An event as referred to herein may be related to an operating system, e.g., low level operations such as opening a file, writing to an output device and the like. For example, in an Android environment, invoking an application (or activity as referred to in the Android environment) includes the OnCreate( ) method. An event may be an invocation of a method, function or procedure, e.g., an invocation of the OnCreate( ) method. For example, code embedded in the original application may intercept a call to the OnCreate( ) method. Any relevant information may then be obtained. For example, an ID value assigned to any view or object presented by the invoked activity may be obtained. Similarly, events such as pausing an activity, resuming an activity, terminating an activity or changing content in a screen may be identified by intercepting OnPause( ), OnResume( ), OnDestory( ) and OnContentChange( ) respectively. Accordingly, a life cycle of an activity may be tracked or monitored in real-time and any event related to the activity may be intercepted or captured, analyzed or processed and, based on an analysis of the event, an action may be performed.

Embodiments of the invention may, in real-time, capture, analyze and process events related to a wireless mobile device. For example, events analyzed and acted upon, in real-time, may be any user action, e.g., a press or click on an item in a screen displayed on a monitor. A relevant event may be a presentation of an item on a screen, e.g., a presentation of a view, screen or a presentation of a menu in a view. Embodiments of the invention may proactively act on an event. For example, based on an event and rules associated with the event, embodiments may choose or select a communication channel for a session involving the wireless mobile device and an agent or other entity in a contact center. Embodiments of the invention may further establish a session over a selected communication channel. For example, a session involving a wireless mobile device and an agent in a contact center may be established over a selected communication channel. A user device may allow for communications over different channels. For example, the same device may include a voice channel for conventional telephone calls, an SMS text channel, a chat ahannel, etc. As described herein, a selected communication channel may be any suitable communication channel. For example, an audio channel enabling a customer to talk to an agent or a data communication channel supporting a web sessions (e.g., a chat session, a document sharing session). Other communication channels selected and or used as described herein may support a text based session, e.g. a short message service (SMS) session or an electronic mail (e-mail) session.

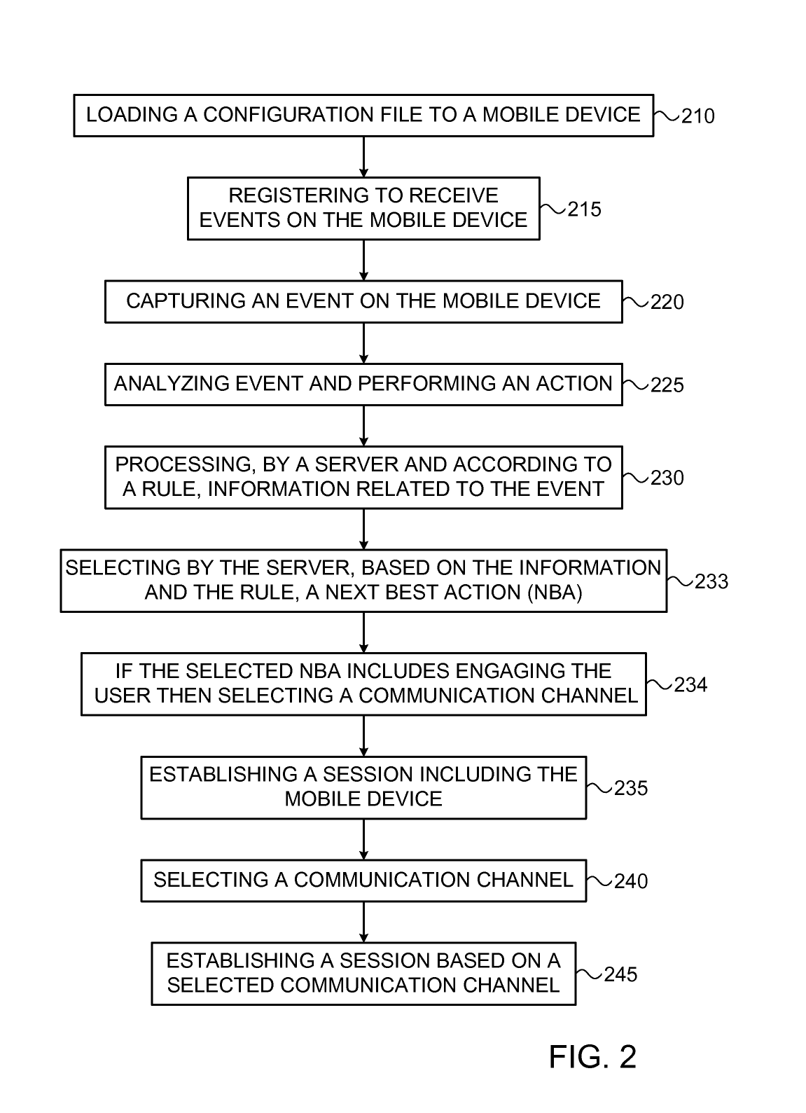

Reference is now made to FIG. 2 that shows a flowchart diagram of a method according to some embodiments of the present invention. As described herein, an embodiment of the method may include receiving, at a server comprising a processor and a memory, data related to an interaction of a user with a mobile device. For example, code embedded in composite application 170 may provide server 150 with data related to an interaction of a user with customer device 160. an embodiment of the method may include determining, at the server, based on the information, a next best action; and if the selected next best action includes engaging the user, then selecting, by the server, a communication channel, and initiating an interaction between the mobile device and a call center representative via the selected channel. For example, based on information captured and provided by code embedded in composite application 170, server 150 may determine the next best action is contacting or engaging the customer and may further select a communication channel to be used in engaging the customer.

As shown by block 210, an embodiment of the method may include loading a configuration file to a mobile device. For example, configuration file 154 may be automatically sent to customer device 160 (e.g., according to a rule or criteria), and may be loaded into a memory of customer device 160. For example, code embedded in composite application 170 may identify an event, e.g., an invocation of the original application (or activity as referred to in the Android environment). For example, the embedded code in an original application may communicate with server module 151 and inform module 151 that the original application was launched. Module 151 may examine a file (not shown) that includes mapping of configuration files to applications or activities.

Module 151 may select a configuration file, e.g., based on an association of the configuration file with an application or activity, and may send the configuration file to customer device 160. In other embodiments, a configuration file may be provided to customer device based on other rules, e.g., upon detecting customer device was turned on or connected to network 130. A configuration file may be selected by server module 151 based on any rule or criteria. For example, a configuration file provided to customer device 160 may be selected based on business or other rules, e.g., the customer category (e.g., Platinum, Gold etc.). As described herein, the configuration file may include references to views or screens provided by the original application and related events. For example, names identifying items in a screen such as an amount input text field in a screen, a user name, a “SEND” or “SUBMIT” button and the like. Information on events related to screens or views may be included in the configuration file, e.g., a text change, a focus change, a click on a clickable item, a select change, etc. Accordingly, provided with information in the configuration file, an embodiment may fully identify events related to an activity. As described herein, mapping of item names to their IDs may be done in real-time or execute time, on customer device 161 or it may be done earlier, e.g., at compile time.

As shown by block 215, an embodiment of the method may include registering to receive events on the mobile device. In an embodiment, by intercepting the onCreate( ) or onResume( ) calls, an embodiment may be notified that an activity was launched or made visible to a user. When an activity is made visible, launched, invoked or otherwise made active, code embedded in an original application may examine some or all items in one or more screens of the activity. For example, each item or control in a view provided by composite application 170 (e.g., view and included items names, controls etc.) may be compared or related to information in configuration file 165 in order to determine if the item or event is of interest.

Based on information in configuration file 165 indicating item and events of interest, a registration for each events of interest may be performed (e.g., by adding a listener to the event). For example, Android enables adding a listener to an event such that when the event occurs, the added listener is notified or executed. Accordingly, any event related to composite application 170 may be captured or intercepted. For example, in a view related to submitting a request for a loan, modification of a mailing address may not be of interest and may accordingly, not be included or indicated in configuration file 165. However, a modification of an amount may be of interest and may accordingly be represented in configuration file 165. In such case, by registering to events based on configuration file 165, code embedded in composite application 170 may not be notified when a mailing address is changed in the above exemplary form, yet the code embedded in composite application 170 may be notified when the above amount is changed. Generally, if an event already has an assigned listener then an embodiment may add itself into a listener chain, e.g., by replacing the assigned listener with code in composite application 170 and storing the assigned listener in a list such that when the event occurs, code in composite application 170 may be executed and the assigned listener is subsequently executed or called. Accordingly, embodiments of the invention may enable undisturbed operation and/or execution of an original application.

As shown by block 220, an embodiment of the method may include capturing an event on the mobile device. For example, an event including a presentation of a specific screen or view or a click on a specific button in a screen may be captured as described herein. As shown by block 225, an embodiment of the method may include analyzing the event and performing an action. For example, when an event for which an embodiment is registered is executed or fired, the event may be analyzed by embedded code and a list of actions associated with the event may be extracted from, or examined in, configuration file 165. Any action may be performed in relation to a captured event. For example, an action may be “send data to a specific server”, “get text from view X”, “store data locally” or “display message to user”. For example, code embedded in composite application 170 may send any information related to a captured event to server 150, e.g., to server module 151. In particular, information sent to server module 151 by code embedded in composite application 170 may include a view ID, a view type, view data (text written in text field) and any data related to events that may occur in relation to a view (e.g., a click on a button in a view). Information sent to a server may be packed in any suitable form. For example, JavaScript Object Notation (JSON) may be used to communicate data between server 150 and code embedded in composite application 170. A default action may include examining a list of listeners and invoking listeners for the event. For example, an action may include activating or calling a listener added to a hash list when registering for an event as described herein.

As shown by block 230, an embodiment of the method may include processing, by a server and according to a rule, information related to the event. For example and as described, any information related to a captured event may be sent to server module 151. Server module 151 may store received information on storage 153 (e.g., in order to collect statistic or other data). Server module 151 may examine and/or process received information based on a rule, threshold or criteria and may further determine, based on received information and a rule, an action to be performed. For example, a business entity for which composite application 170 is produced (e.g., a bank) may define business or other rules that may be used by server 150 in order to select or determine an NBA. For example, server 150 may determine that an NBA is to have an agent interact with a customer. A communication channel for an interaction between an agent and a customer may be selected based on a business or other rule. For example, a bank for which composite application 170 is produced may provide business rules that may be used by server 150 in selecting an action and/or a communication channel.

As shown by block 233, an embodiment of the method may include selecting by the server, based on the information and the rule, a next best action (NBA). For example and as described herein, server 150 may store (e.g., on storage 153) one or more rules and may use stored rules in order to determine or select a next best action (NBA).

As shown by block 234, an embodiment of the method may include determining if a selected NBA includes engaging a user and, if so, then selecting a communication channel to be used for communicating with the user.

As shown by block 235, an embodiment of the method may include selecting to establish a session (e.g., a communication session) including or using the mobile device. Accordingly, embodiments of the invention may automatically select to engage a customer or user based on an event related to a mobile device operated by the customer or user. For example, by analyzing data related to an event according to business or other rules, server module 151 may determine that an action to be performed includes establishing a session between customer device 160 and agent device 110. In other cases, scenarios or embodiments, the session to be established, as determined by server module 151, may include an application (e.g., a web application or an Interactive Voice Response (IVR)). It will be understood that a session between a customer or user device and any applicable entity may be automatically selected and/or established as described herein. Determining to engage a user on a mobile device may be based on any criteria, rule, logic, threshold or parameter. Engaging a user may include establishing a communication session with the user (e.g., establishing telephone call between the customer and an agent in a contact center). Engaging a user or a user device may include sending a message to the user or to the user's device. For example, engaging a user or device may include sending an SMS message to device 160 or calling device 160. For example, a system may select to engage a “Gold” customer when a specific event on the “Gold” customer's mobile device is captured but, when a similar event is captured on a device of a regular customer, the system may determine to ignore the event. Since any information related to an event is available to server module 151, any relevant rule may be applied. For example, rules related to the customer, the mobile device used, the time of day, a product or service and the like may all be applied to data related to an event provided to server module 151 by embedded code as described herein.

As shown by block 240, an embodiment of the method may include selecting a communication channel. For example, if, based on a captured event it is determined that a user on customer device 160 is to be engaged in a session then, based on data related to an event captured on customer device 160 and a set of rules, server module 151 may assign weights to a set of possible communication channels. The communication channel with which the highest weight may then be selected for engaging a user operating customer device 160. Generally, a communication channel may be or may include any element required in order to communicate with a customer's device. For example, a user or device may be reachable over a voice or audio channel (e.g., by calling a telephone number associated with device 160). A user or device may be reachable over a data channel, e.g., by a chat session over a network. Other communication channels may enable text messages (e.g., SMS) and the like. An embodiment may select to engage a customer over a selected channel based on one or more rules related to one or more aspects.

For example, if, in a view with ID equal to “1”, a an item of type “text field” has a value of “Gold Customer” then the weight of a voice channel may be increased by 30 and a web chat channel weight may be incremented by 10. In another or same case, in a view with ID equal to “2”, a an item of type “text field” has a value of “Take Loan” then the weight of a voice channel may be increased by 80 and weight of a voice channel may be increased by 2. It will be understood that complex rules may include any calculations or computations such that any rules or conditions (e.g., business rules related to customers, products, available agents or other resources and the like) may all be applicable. At end of a process of assigning weights to communication channels, the channel with the highest weight may be selected as the channel over which a session with the customer is established.

Server module may communicate with code embedded in composite application 170. Server module may communicate or interact with code of the original application. For example, server module 151 may send a channel selection to customer device 160. Server module 151 may send any relevant information to customer device 160. For example, a telephone number to call. For example, based on an event processed as described herein, server module 151 may select a specific agent (e.g., based on skills of agents provided to server module 151). Server module may send the direct number of the selected agent to customer device 160. Any other information that may be useful in establishing a session may be provided.

As shown by block 245, an embodiment of the method may include establishing a session based on a selected communication channel. For example, as described herein, one of a voice, chat, SMS, Multimedia Messaging Service (MMS), web or mobile channels may be selected. A message sent from server module 151 to customer device 160 may include an indication of the selected channel and additional information that may depend on the selected channel. For example, if a voice channel is selected then a phone number may be included in the message. In another case, if the selected channel is a web channel then a unique resource locator (URL) may be provided. Accordingly, a session may be established based on a selection made by server module and based on information provided by server module 151.

In an embodiment, a session may be established automatically, e.g., by code in composite application 170. In other embodiments, an indication may be provided to a user. For example, based on a selected channel and additional parameters provided by server module 151, code in composite application 170 may display information to a user, prompting the user to connect to a suggested entity using a suggested communication channel. For example, using Android Dialog or other means, a pop-up may be displayed on a screen of customer device 160 prompting the user to connect to a call center, possibly identifying a specific agent in the call center or otherwise providing the user with relevant information.

Accordingly, as described herein, embodiments of the invention may capture, on the user mobile device, an event related to an interaction of the user with an application executed on the mobile device. Embodiments may send information related to the event to a server, may select, by the server, based on the information sent, an interaction channel, and, may facilitate an interaction between the mobile device and a call center or other entity, according to the selected interaction or communication channel. Generally, facilitating an interaction may include determining relevant parameters (e.g., a telephone number or a network address) and establishing a session between at least a first and second parties. For example, facilitating a session or interaction may include determining a telephone number of a customer (e.g., a telephone number of, or associated with, device 160) and establishing a telephone call between device 160 and device 110. Facilitating an interaction may include enabling an agent operating device 110 to exchange text messages with a user of device 160, e.g., by establishing network connections (e.g., a transmission control protocol (TCP)) between devices 110 and 160. Facilitating a connection, session or interaction may include automatically dialing a number. For example, a user of device 160 may be presented with an option to talk to an agent and, upon indication of the user that he or she is interested to talk to an agent, a number may be automatically dialed (e.g., by code embedded in composite application 170) such that a telephone call between the user and an agent is established.

As described herein, capturing an event may be performed by code (or a capturing module) weaved into an original application, a woven original application (that includes a capturing module and/or other embedded code) may be provided to a mobile device as a single object. A captured event and related information may be sent to a server that may be configured to select an interaction or communication channel based on one or more rules associated with the original application and/or with the event. It will be understood that any action may be selected by the server and that selecting an interaction or communication channel may be one of a number of actions selected and performed, e.g., based on a rule stored on the server.

In some embodiments, a configuration file may be dynamically loaded, e.g., during an execution of composite application 170. Embodiments of the invention enable replacing configuration file 165 in real-time, e.g., while composite application 170 is running or active. For example, server module 151 may keep track of all customer devices that received configuration file 154. Upon detecting that configuration file 154 on storage 153 was modified or replaced by a new version, server module 151 may automatically send the updated version of configuration file 154 to all customer devices that received the previous (now outdated) version of configuration file 154. Accordingly, embodiments of the invention enable dynamically replacing a set of rules based on which a user may be automatically engaged using an automatically selected communication channel. In particular, code embedded in an original application does not need to be modified in order to replace or update business or other rules used as described herein. Since, as described, IDs may be obtained on the fly, e.g., from an active application, when provided with an updated configuration file that defines updated rules, embedded code may extract relevant IDs (e.g., based on names of views or controls included in an updated configuration file) from an active application and may further perform an embodiment of the method as described herein. Controls may be, for example, GUI elements used by a user to control an application. Views may be any graphical information displayed on a display of a computing device.

As described herein, embodiments of the invention may detect and analyze, in real time, user actions in the mobile application. For example, using AspectJ™, code embedded in an original application may detect and analyze, in real time, user actions in the mobile application. An embodiment may proactively suggest a communication channel to facilitate an interaction between a user of a mobile device and an agent or application. By utilizing embedded code and a configuration file as described herein, embodiments of the invention enable dynamically and/or automatically replacing, updating or loading a configuration file in real-time or on-the-fly, while the relevant application or activity is active or running. By embedding code as described herein, an original application may be unaffected. As referred to in the art, code is embedded in an original application with zero footprint.

By detecting and analyzing user actions and determining an action (e.g., communicate with an agent) that is best according to a business or other rule embodiments enable influencing a business process. Generally, a next best action (NBA) or best-next action or next-best activity as known in the art) is determined or selected by considering a number of different actions that may be taken, e.g., for a specific customer and/or specific service or product. Marketing objectives or interests as well as customer's interests are typically taken into account. Business rules described herein may reflect aspects similar to those considered in determining an NBA. An NBA may be an action selected from a plurality of possible actions. A specific action may be determined to be the best next action (or next best action) based on one or more rules, e.g., business rules. For example, possible actions may be contacting a customer by e-mail, calling the customer via a telephone channel and/or sending an SMS message to the customer. Based on one or more rules, a system may determine that calling the customer is the best next action. For example, a rule may dictate that if a customer is interested in a specific product then the best action in promoting sales of that specific product is to talk to the customer. However, if that or other customer is interested in a second product, an associated rule may indicate that the best next action is sending mail to the customer. A next best action is determined based on past events. For example, depending on products previously investigated by a customer, the amount of time spent in reviewing a product (e.g., online, in a web site) a next best action may be selected or determined Accordingly, depending on actions of a user, the next best action may be selected. An NBA may be selected, e.g., by server module 151 based on any information stored on server 150. For example, a list of possible actions may be stored on server 150 (e.g., in storage 153). An NBA may be selected from such or other list.

An NBA selected or chosen according to embodiments of the invention may be, or may include any relevant action. For example, an NBA may be displaying or showing marketing information on a customer's (or potential customer's) device. In another example, a survey related to a product or service may be provided (e.g., graphically) on a customer's device. In yet another example, an NBA may include suggesting offers for a service or product.

By further suggesting a communication channel and readily establishing a connection over the suggested channel, embodiments further enable control on a business process. Accordingly, rather than a reactive response to a process, embodiments enable real-time, proactive approach and response to an ongoing process, is it progresses.

Accordingly, as described herein, a computer-implemented method may include capturing, on a user mobile device, an event related to an interaction of the user with an application executed on the mobile device and may send information related to the event to a server. For example, server 150 may use rules (e.g., business rules) to determine or select, based on information provided by code embedded in composite application 170 an action, e.g., an NBA. A selected or chosen action may be to engage the user. If the selected action includes engaging the user then the server may select a communication channel and may cause or facilitate an interaction, over the selected communication channel, between the user's mobile device and a call center entity (e.g., an agent or web site).

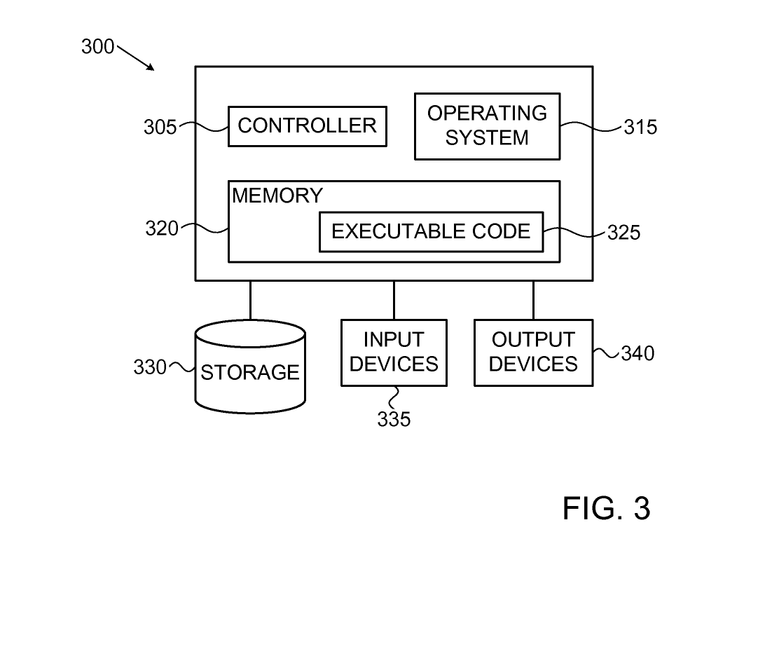

Reference is made to FIG. 3, a high level block diagram of an exemplary computing device according to embodiments of the present invention. Computing device 300 may include a controller 305 that may be, for example, a central processing unit processor (CPU), a chip or any suitable computing or computational device, an operating system 315, a memory 320, a storage 330, an input devices 335 and an output devices 340. Where applicable, components shown in FIG. 1 may be or may include components shown included in, or attached to, device 300. For example, server 150 may be or include a device 300, and storage 330 may be equivalent to, in that context, storage 153. Similarly, where applicable, customer device 160 and/or agent device 110 may include components shown included in device 300. For example, executable code 325 may be or may include composite application 170.

Operating system 315 may be or may include any code segment designed and/or configured to perform tasks involving coordination, scheduling, arbitration, supervising, controlling or otherwise managing operation of computing device 300, for example, scheduling execution of programs. Operating system 315 may be a commercial operating system. Memory 320 may be or may include, for example, a Random Access Memory (RAM), a read only memory (ROM), a Dynamic RAM (DRAM), a double data rate (DDR) memory chip, a Flash memory, a non-volatile memory or other suitable memory units or storage units. Memory 320 may be or may include a plurality of, possibly different memory units. In an embodiment, memory 320 may be a non-transitory readable medium.

Executable code 325 may be any executable code, e.g., an application, a program, a process, task or script. Executable code 325 may be executed by controller 305 possibly under control of operating system 315. For example, agent module 111, server module 151, and/or composite application 170 may be executed by controller 305. Executable code 325 may, in different devices, represent a module, e.g., agent module 111, server module 151, and/or composite application 170.

For example, agent device 110, customer device 160 and server 150 may include elements included in device 300 and executable code 325 may be an application or module similar to agent module 111, code embedded in composite application 170 or server module 151 respectively. Where applicable, executable code 325 may carry out operations described herein in real-time. Computing device 300 and executable code 325 may be configured to update, process and/or act upon information at the same rate the information, or a relevant event, are received. In some embodiments, more than one computing device 300 may be used. For example, a plurality of computing devices that include components similar to those included in computing device 300 (e.g., a plurality of customer devices similar to customer device 160) may be connected to a network and used as a system.

Storage 330 may be or may include, for example, a hard disk drive, a floppy disk drive, a CD-Recordable (CD-R) drive, a universal serial bus (USB) device or other suitable removable and/or fixed storage unit. Content (e.g., configuration files) may be stored in storage 330 and may be loaded from storage 330 into memory 320 where it may be processed by controller 305. In some embodiments, some of the components shown in FIG. 3 may be omitted. For example, memory 320 may be a non-volatile memory having the storage capacity of storage 330. Accordingly, although shown as a separate component, storage 330 may be embedded or included in memory 320.

Input devices 335 may be or may include a mouse, a keyboard, a touch screen, pad, or any suitable input device. It will be recognized that any suitable number of input devices may be operatively connected to computing device 300 as shown by block 335. Output devices 340 may include one or more displays, speakers and/or any other suitable output devices. It will be recognized that any suitable number of output devices may be operatively connected to computing device 300 as shown by block 340. Any applicable input/output (I/O) devices may be connected to computing device 300 as shown by blocks 335 and 340. For example, a wired or wireless network interface card (NIC), a universal serial bus (USB) device or external hard drive may be included in input devices 335 and/or output devices 340.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 320, computer-executable instructions such as executable code 325 and a controller such as controller 305.

Some embodiments may be provided in a computer program product that may include a non-transitory machine-readable medium, stored thereon instructions, which may be used to program a computer, or other programmable devices, to perform methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a server computer or any other suitable computing device. Unless explicitly stated, the method embodiments described herein are not constrained to a particular order or sequence. Additionally, some of the described method embodiments or elements thereof can occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A computer-implemented method of automatically engaging a user of a mobile device, the method comprising:
capturing, on the user mobile device, an event related to an interaction of the user with an application executed on the mobile device;
sending information related to the event to a server;
selecting by the server, based on the information, a next best action (NBA); and
if the selected next best action includes engaging the user then selecting a communication channel and facilitating an interaction between the mobile device and a call center entity according to the selected channel.

2. The method of claim 1, wherein capturing the event is performed by a capturing module included in the application and wherein the application and the included capturing module are provided to the mobile device as a single application.

3. The method of claim 1, wherein the server is configured to select the NBA based on at least one rule associated with the application and with the event.

4. The method of claim 1, wherein the server is configured to select an action based on the event.

5. The method of claim 1, wherein information related to the event comprises at least one of: a screen presented by the application and an interaction of a user with the application.

6. The method of claim 1, wherein the event is one of: a screen event and a user input event.

7. A system for automatically engaging a user of a mobile device, the system comprising:
a module to capture, on a user mobile device, an event related to an interaction of the user with an application executed on the mobile device and to send information related to the event to a server;
a server to select, based on the information, a next best action (NBA), and, if the selected action includes engaging the user then the server is to select a communication channel and to facilitate an interaction between the mobile device and a call center entity according to the selected channel.

8. The system of claim 7, wherein the module is embedded in the application and wherein the application and the module are provided to the mobile device as a single application.

9. The system of claim 7, wherein the server is configured to select the NBA based on at least one rule associated with the application and with the event.

10. The system of claim 7, wherein the server is configured to select an action based on the event.

11. The system of claim 7, wherein information related to the event comprises at least one of: a screen presented by the application and an interaction of a user with the application.

12. The system of claim 7, wherein the event is one of: a screen event and a user input event.

13. A method of automatically communicating with a user of a mobile device, the method comprising:
receiving, at a server comprising a processor and a memory, data related to an interaction of a user with an application executed on a mobile device;
determining, at the server, based on the information, a next best action; and
if the selected next best action includes engaging the user then selecting a communication channel and initiating an interaction between the mobile device and a call center representative via to the selected channel.

14. The method of claim 13, wherein data related to the interaction of the user is obtained by a module embedded in the application and wherein the application and the module are provided to the mobile device as a single application.

15. The method of claim 13, wherein the server is configured to select a next best action based on at least one rule associated with the application and with the interaction.

16. The method of claim 13, comprising receiving, by the server, data related to an event, and selecting an action based on a rule and the event,.

17. The method of claim 16, wherein the event is one of: a screen event and a user input event.
